(19) United States
(12) Patent Application Publication
(10) Pub. No.: US 2009/0201587 A1
(43) Pub. Date: Aug. 13, 2009

(54) OPTICAL FILTER AND DISPLAY DEVICE HAVING THE SAME

(75) Inventors: Hong Ik Kim, ChungCheongNam-Do (KR); Dong Keun Shin, ChungCheongNam-Do (KR); Dong Hyun Park, ChungCheongNam-Do (KR); Dae Chul Park, ChungCheongNam-Do (KR); Shin Wook Kim, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/368,560

(22) Filed: Feb. 10, 2009

(30) Foreign Application Priority Data
Feb. 13, 2008 (KR) 10-2008-0013111

(51) Int. Cl. G02B 1/11

(52) U.S. Cl. 359/588

(57) ABSTRACT

An optical filter for a display device placed in front of a display panel 1000 of the display device includes a first layer 310 which is formed at a first area A1 and has a first light blocking ratio. The amount of light transmitted through the first area A1 is smaller than the amount of light transmitted through an adjacent area to the first area A1 such that the first area A1 becomes distinguished to form a dark mark or the adjacent area becomes distinguished to form a bright mark. The optical filter further includes a second layer 320 which is formed at a second area A2 and has a second light blocking ratio lower than the first light blocking ratio. The amount of light transmitted through the first area A1 is smaller than the amount of light transmitted through the second area A2 such that the first area A1 becomes distinguished to form the dark mark or the second area becomes distinguished to form a bright mark. The second layer 320 can be a coating layer which is printed with a material with the second light blocking ratio or a film containing a material with the second light blocking ratio. The second light blocking ratio can be 70˜99%. The first layer 310 can be a coating layer of a black ceramic material or a film containing a black ceramic material. A display device includes the display panel 1000 displaying an image; and the optical filter.

### CROSS-REFERENCE TO RELATED APPLICATION

This application claims the benefit of Korean Patent Application No. 2008-0013111 filed on Feb. 13, 2008 in the Korean Intellectual Property Office, the disclosure of which is incorporated herein by reference.

### BACKGROUND OF THE INVENTION

1. Field of the Invention

The present invention relates to an optical filter and a display device having the same, more particularly, to an optical filter which makes it possible to reduce the production cost and time and its thickness and a display device having the same.

2. Description of the Related Art

A display device includes a television, a computer monitor, a portable display device, and so on. A display devices is recently getting larger sized and thinner.

Accordingly, a flat panel display (FPD) device such as a plasma display panel (PDP) device, a liquid crystal display (LCD) device, a field emission display (FED) device, and an organic light emitting display (OLED) device takes the place of a cathode ray tube (CRT) device, which was representative of a display device.

Especially, a PDP device is in the limelight since it has excellent display characteristics such as high luminance, a high contrast ratio, low after-image, and a wide viewing angle.

A PDP device causes gas discharge between electrodes by applying a direct or alternating voltage to the electrodes. The fluorescent material is irradiated with ultraviolet rays caused by the gas discharge to be activated, whereby light is generated. A PDP device displays images by using the generated light.

However, a PDP device has drawbacks in that a large amount of electromagnetic waves and near infrared rays is emitted due to it intrinsic characteristics. The electromagnetic waves and near infrared rays emitted from a PDP device may have a harmful effect to the human body, and cause malfunction of precision appliances such as a cellular phone and a remote controller. Further, a PDP device has lower color purity than a CRT device due to orange color light emitted from gas such as He or Xe.

Therefore, a PDP device uses a PDP filter in order to solve the problems. A PDP filter is installed in front of a display panel.

The trend in the development and production of a display device shows that manufacturers concentrated on improving the qualities of display devices, but nowadays, the qualities become equal and thus the exterior design of a display device becomes an important factor affecting the competitiveness of a display device.

In order to increase customer's visual satisfaction, a mark to be lighted is provided on the exterior of a display device. Typically, in order to increase the competitiveness of a display device, a manufacturer's company name or a trademark is displayed on the exterior.

For this purpose, an opening is formed on the case of a display device. A member on which a mark is formed is installed at the opening. Light from the display panel or other light sources goes through the member to light the mark.

However, such a display device has a drawback that forming the opening and installing the member increases the cost and time. In addition, it is difficult to make the display device thin.

Furthermore, since light from the display panel has to be also provided for an area where the member is installed, typically the lower area of the case of the display device, it may be required to change the internal structure of the display device. In addition, since light has to be emitted toward not only the front direction but also the lower area of the case, light loss arises.

### SUMMARY OF THE INVENTION

The present invention has been made to solve the foregoing problems. An object of the present invention is to provide a lighted mark and thereby impress the name of a manufacturer or goods on customers and to increase customer's visual satisfaction and thereby attract customers.

Another object of the present invention is to reduce the manufacturing cost and time and thereby improve the productivity.

Still another object of the present invention is to make a display device thin and thereby increase the competitiveness thereof.

Still another object of the present invention is to achieve the above-mentioned visual effect and to prevent light loss and thereby improve the efficiency.

The present invention provides an optical filter for a display device placed in front of a display panel of the display device, the optical filter including a first layer which is formed on a first area and has a first light blocking ratio, wherein the amount of light transmitted through the first area is smaller than the amount of light transmitted through an adjacent area to the first area such that the first area becomes distinguished to form a dark mark or the adjacent area becomes distinguished to form a bright mark.

Preferably, the optical filter further includes a second layer which is formed at a second area and has a second light blocking ratio lower than the first light blocking ratio, wherein the amount of light transmitted through the first area is smaller than the amount of light transmitted through the second area such that the first area becomes distinguished to form the dark mark or the second area becomes distinguished to form a bright mark.

The second layer can be a coating layer which is printed with a material with the second light blocking ratio or a film containing a material with the second light blocking ratio.

Preferably, the second light blocking ratio is 70˜99%.

The first layer can be a coating layer of a black ceramic material or a film containing a black ceramic material.

Furthermore, the present invention also provides a display device including the display panel displaying an image and the optical filter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross sectional view illustrating an optical filter according to the first embodiment of the present invention;

FIG. 2 is a front view illustrating a mark bearing layer of the optical filter in FIG. 1;

FIG. 3 is a front view illustrating a first layer and a second layer forming the mark bearing layer in FIG. 2;

FIG. 4 is a cross sectional view of the mark bearing layer in FIG. 3;

FIGS. 5 to 9 are enlarged cross sectional views of mark bearing layers according to the second to sixth embodiments;

FIG. 10 is an exploded view illustrating an optical filter according to the seventh embodiment;

FIG. 11 is an exploded view illustrating an optical filter according to the eighth embodiment;

FIG. 12 is an exploded view illustrating a display device having the optical filter in FIG. 10; and

FIG. 13 is an exploded view illustrating a display device having the optical filter in FIG. 11.

### DETAILED DESCRIPTION OF THE EXEMPLARY EMBODIMENT

The present invention will now be described more fully hereinafter with reference to the accompanying drawings, in which exemplary embodiments thereof are shown.

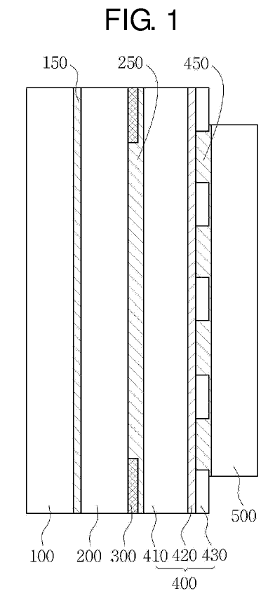

FIG. 1 is a cross sectional view illustrating an optical filter for a display device according to the first embodiment.

The optical filter in FIG. 1 includes an anti reflection layer 100, a base substrate 200, a mark bearing layer 300, a conductive mesh layer 400 and a protective layer 500.

The anti reflection layer 100 prevents the reflection of light and thereby prevents the image quality from deteriorating due to the reflection of light. The anti reflection layer 100 can include a functional film performing a function of color compensation. The anti reflection layer 100 can be formed by stacking together not only an anti reflection film but also a near infrared ray shielding film, a neon light blocking film, etc.

The anti reflection layer 100 adheres to the base substrate 200 to by means of a first adhesive layer 150. A transparent glass substrate can be used as the base substrate 200. Specifically, a heat strengthened glass substrate is preferable as the base substrate 200. A substrate of resin such as polycarbonate, polyethylene terephthalate, etc can also be used as the base substrate 200.

The mark bearing layer 300 includes a first layer 310 and a second layer 320. The mark bearing layer 300 will be described more fully below.

The conductive mesh layer 400 adheres to the base substrate 200 by means of a second adhesive layer 250. The conductive mesh layer 400 includes a base film 410, a bonding layer 420, and a thin metal pattern 430.

The base film 410 can be made of resin such as polyethylene terephthalate.

The thin metal pattern 430 performs a function of blocking electromagnetic waves produced by a display panel. The thin metal pattern 430 is bonded to the base film 410 by means of the bonding layer 420. In order to forming the thin metal pattern 430, first a thin metal film of copper, etc is bonded onto the base film 410. Then, the thin metal film bonded onto the base film 410 is patterned by etching, etc. to form the thin metal pattern 430.

The protective layer 500 adheres to the conductive mesh layer 400 by means of a third adhesive layer 450. The protective layer 500 is somewhat smaller than the conductive mesh layer 400. Accordingly, the peripheral area of the thin metal pattern 430 can be exposed to the outside, thereby being electrically grounded.

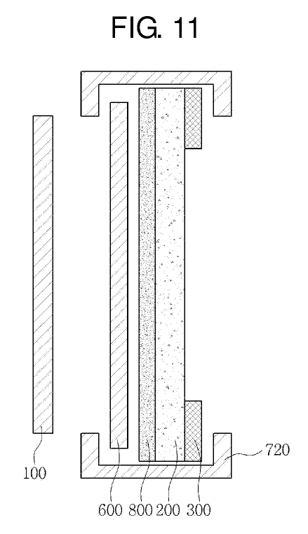

The optical filter can include other layers. The structures of the optical filter in FIG. 1 and the optical filters in FIGS. 10 and 11 which will be described below are given only to exemplify embodiments of the present invention, not to limit the present invention thereto. The optical filter can include various layers as the constituent layers. The constituent layers can be stacked in various orders. The mark bearing layer 300 can be placed in various positions.

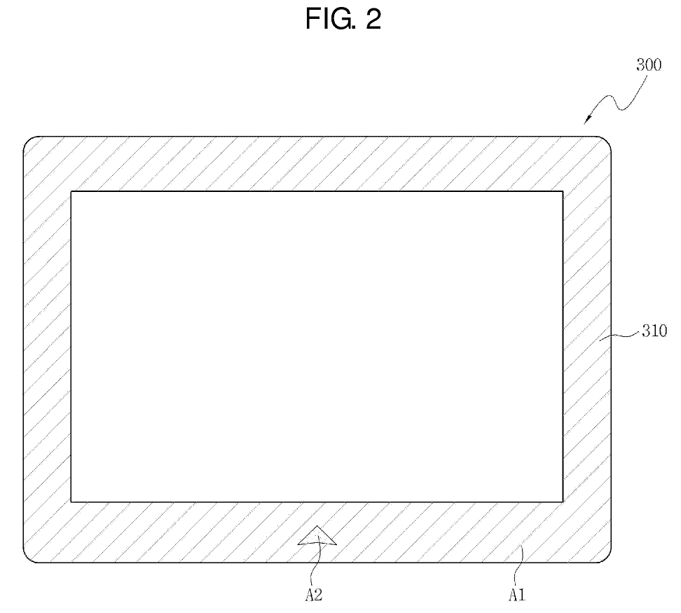

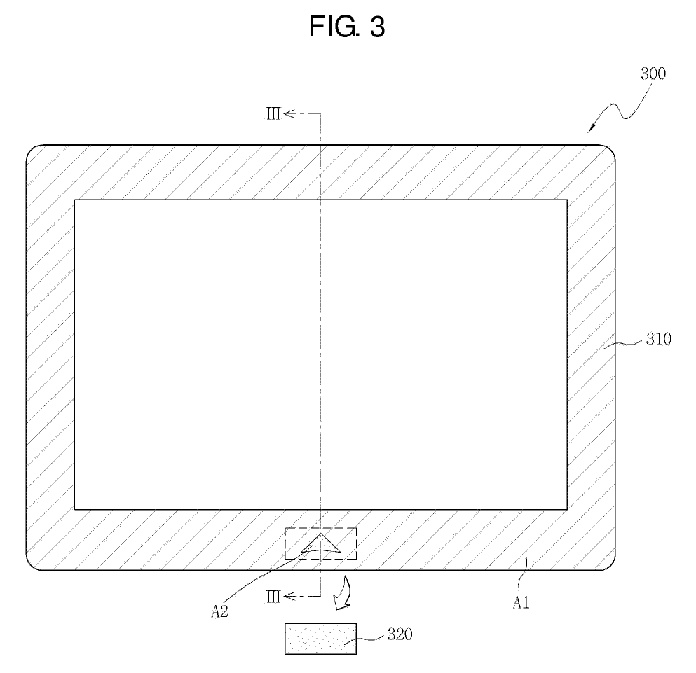

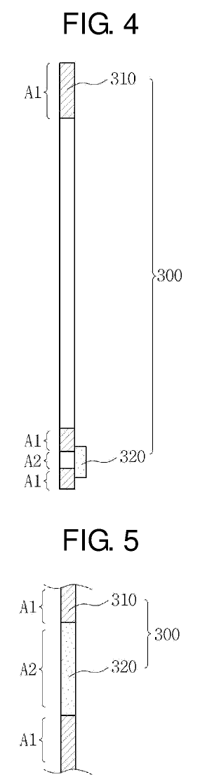

FIG. 2 is a front view illustrating the mark bearing layer 300 of the optical filter in FIG. 1; FIG. 3 is a front view illustrating the first layer 310 and the second layer 320 forming the mark bearing layer 300 in FIG. 2; and FIG. 4 is a cross sectional view of the mark bearing layer 300 taken along line III-III in FIG. 3.

The mark bearing layer 300 shown in FIG. 2 includes the first layer 310 having a first light blocking ratio and the second layer 320 having a second light blocking ratio which is lower than the first light blocking ratio.

Preferably, the mark bearing layer 300 is formed on the periphery of the optical filter.

The first layer 310 is formed at a first area A1. In FIG. 2, the first area A1 is the peripheral area of the optical filter other than the effective display area. Since the first layer 310 having the high light blocking ratio is formed on the area other than the effective display area, it is possible to increase image quality by virtue of contrast.

The first layer 310 can be a coating layer or a film containing black pigment, especially black ceramic material. The black ceramic material can be made of paste in which metal ingredients such as Cr, Cu, iron oxide, manganese oxide, etc. are dispersed in constituents of glass including Si, Bi₂O₃, B₂O₃, Na, etc.

The black ceramic material is provided on the periphery of the base substrate 200, blocking light emitted from the display panel. Accordingly, the periphery looks black and no image is displayed on the periphery.

The second layer 320 is formed at a second area A2. The second layer 320 has the second light blocking ratio lower than the first layer 310. The second layer can be a coating layer which is printed with a material with the second light blocking ratio or a film containing a material with the second light blocking ratio.

Due to the difference between the first light blocking ratio and the second light blocking ratio, the amounts of light transmitted through the first area A1 and the second area A2 are different from each other. This difference enables the mark bearing layer 300 to display a specific mark (the mark [symbol] ).

The second layer can also include black ceramic material. In this case, the percentage of the black ceramic material contained in the second layer will be lower than that in the first layer. For example, in case that the black ceramic material is mixed with a solution (organic vehicle), and the first and second layers are formed using the mixture, the first layer will be able to be formed using the mixture containing 15˜30% of the solution and the second layer will be able to be formed using the mixture containing about 30˜50% of the solution.

The second light blocking ratio is preferably 70˜99%. This means that the second light transmittance is 1˜30%. The second light transmittance is more preferably 1˜5%. Accordingly, the mark can be hardly distinguished in normal times. However, while the display device (or another dedicated light source such as an LED for supplying the mark bearing layer with light) is on, the mark ( [symbol] in FIGS. 2 and 3) of the second area is lighted to be distinguished, which makes it possible to advertise the goods and enhance the image of the manufacturer.

In order to obtain more various visual effects, at least one of the first and second layers 310, 320 can have color.

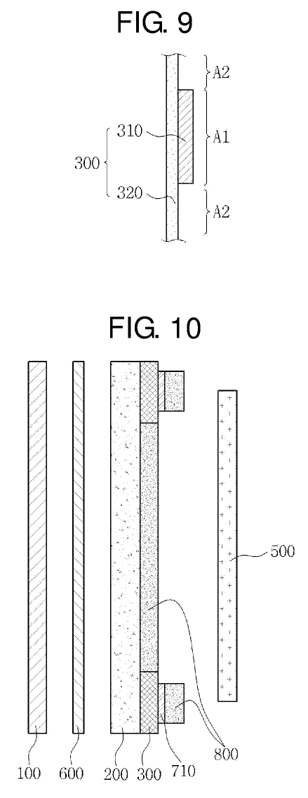

Although FIGS. 2 to 4 show the embodiment in which the second area A2 is distinguished to form the bright mark (the mark [symbol] ), a first area A1 can be distinguished to form a dark mark as in FIG. 9 which will be described below.

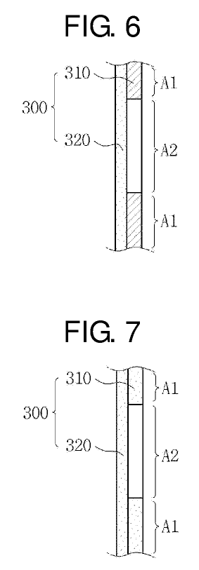

In FIG. 4, the first layer 310 and the second layer 320 are layered in the order named. However, a first layer and a second layer can be layered in the reverse order as in FIG. 6. In addition, a first layer and a second layer can be formed on the same level as in FIG. 5.

In FIG. 4, the first layer 310 and the second layer 320 are formed in contact with each other, but the present invention is not limited thereto. For example, other layer(s) can be interposed between the first layer 310 and the second layer 320. That is, the first layer 310 and the second layer 320 can be formed apart from each other.

Preferably, the first layer 310 is formed only at the first area. However, as shown in FIG. 4, the second layer 320 can be formed at not only the second area but also the first area. Of course, a second layer can be formed only at a second area A2 as shown in FIG. 5.

FIG. 5 is an enlarged cross sectional view of a mark bearing layer 300 according to the second embodiment.

FIG. 5 shows the embodiment in which a second layer 320 is formed on the same level as a first layer 310. In this embodiment, the first layer 310 and the second layer 320 can be formed in the order named, in the reverse order or at the same time.

In this embodiment, the first layer 310 is formed only at the first area A1 and the second layer 320 is formed only at the second area A2.

FIG. 6 is an enlarged cross sectional view of a mark bearing layer 300 according to the third embodiment.

FIG. 6 shows the embodiment in which a first layer 310 is layered behind a second layer 320, which is different from the embodiment in FIG. 4 in which the first layer 310 is layered ahead of the second layer 320. For example, the mark bearing layer 300 can be made by coating the second layer 320 on the rear surface of the base substrate 200, and then coating the first layer 310 on the second layer 320.

FIG. 7 is an enlarged cross sectional view of a mark bearing layer 300 according to the fourth embodiment.

A first layer 310 and a second layer 320 can have the same light blocking ratio. As shown in the figure, the first layer 310 is formed only at a first area A1 and the second layer 320 having the same light blocking ratio as the first layer 310 is formed at both the first area A1 and a second area A2. In this case, due to the difference in the thickness of the layer blocking light, the amount of light transmitted through the first area at which both the first layer 310 and the second layer 320 are layered is different from the amount of light transmitted through the second area at which only the second layer 320 is formed. This difference enables the first area A1 or the second area A2 to form a dark mark or a bright mark, respectively.

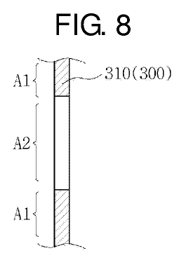

FIG. 8 is an enlarged cross sectional view of a mark bearing layer 300 according to the fifth embodiment.

A second layer can be excluded from an optical filter. In this case, the amount of light transmitted through a first area is different from the amount of light transmitted through an adjacent area to the first area, which enables the first area or the adjacent area to form a dark mark or a bright mark, respectively. Accordingly, a second area can have high brightness.

Although the second layer is excluded, the light transmitted through the second area may be blocked to some degree by other constituent layers.

FIG. 9 is an enlarged cross sectional view of a mark bearing layer 300 according to the sixth embodiment.

In FIGS. 2 to 8, the second area A2 forms the bright mark. However, it is also possible that a first area forms a dark mark as in FIG. 9.

In some embodiments, a mark bearing layer can have other layers such as a third layer, etc as well as a first layer and a second layer in order to display more various marks. That is, an optical filter can includes second to n^{th} (n≧2) layers which are formed at second to n^{th} areas and have second to n^{th} light blocking ratios lower than a first light blocking ratio, respectively. The amount of light transmitted through a first area is smaller than the amounts of light transmitted through the second to n^{th} areas, which makes it possible to display a mark.

FIG. 10 is an exploded view illustrating an optical filter according to the seventh embodiment. (Adhesive layers are not depicted in the figure)

The optical filter in the figure includes an anti reflection layer 100, a color compensation layer 600, a base substrate 200, a mark bearing layer 300, a conductive paste layer 710, a conductive film layer 800, and a protective layer 500.

The conductive paste layer 710 such as a silver paste layer is interposed between the mark bearing layer 300 and the conductive film layer 800. The conductive paste layer 710 is electrically grounded and thereby makes it possible to discharge electromagnetic waves in the optical filter.

The protective layer 500 covers the conductive film layer 800 to prevent the oxidation and contamination of the conductive film layer 800. The protective layer 500 is somewhat smaller than the conductive film layer 800, and thereby the periphery of the optical filter is exposed to the outside. Accordingly, the conductive paste layer 710 can be grounded.

FIG. 11 is an exploded view illustrating an optical filter according to the eighth embodiment. (Adhesive layers are not depicted in the figure)

The optical filter includes an anti reflection layer 100, a color compensation layer 600, a conductive film layer 800, a base substrate 200, and a mark bearing layer 300.

Since the conductive film layer 800 is not exposed to the outside, a protective layer 500 may be excluded from the optical filter.

The side surface of the optical filter is covered with a conductive tape 720 such as a cooper tape. The conductive tape 720 makes it possible to dispose of electromagnetic waves in the optical filter.

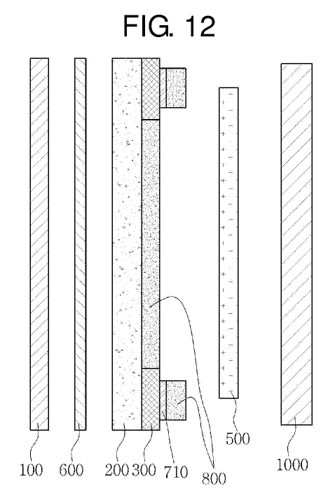

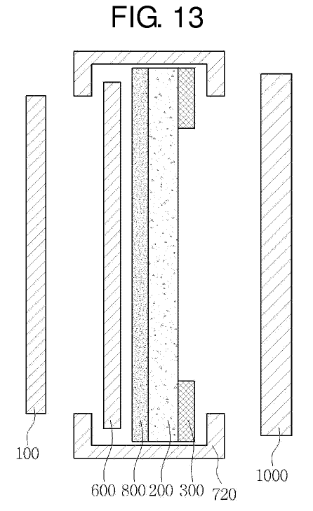

FIG. 12 is an exploded view illustrating a display device having the optical filter in FIG. 10, and FIG. 13 is an exploded view illustrating a display device having the optical filter in FIG. 11.

The display device includes the optical filter and a display panel 1000.

The display panel 1000 is placed at the opposite side of the optical filter to a viewer. Once the display panel is supplied with electric, it converts electric signals into video signals to output images through the optical filter to a viewer.

Hereinbefore, the present invention has exemplified the PDP filter and the PDP device, but the present invention is not limited thereto. A mark bearing layer and an optical filter according to the present invention are also applicable to a variety of display devices such as an LCD device, an organic light emitting diode (OLED) device, a field emission display (FED) device, and so on.

What is claimed is:

1. An optical filter for a display device placed in front of a display panel of the display device, the optical filter comprising a first layer which is formed at a first area and has a first light blocking ratio,
wherein the amount of light transmitted through the first area is smaller than the amount of light transmitted through an adjacent area to the first area such that the first area becomes distinguished to form a dark mark or the adjacent area becomes distinguished to form a bright mark.

2. The optical filter according to claim 1, further comprising a second layer which is formed at a second area and has a second light blocking ratio lower than the first light blocking ratio,
wherein the amount of light transmitted through the first area is smaller than the amount of light transmitted through the second area such that the first area becomes distinguished to form the dark mark or the second area becomes distinguished to form a bright mark.

3. The optical filter according to claim 2,
wherein the second layer is a coating layer which is printed with a material with the second light blocking ratio or a film containing a material with the second light blocking ratio.

4. The optical filter according to claim 2,
wherein the first layer is layered ahead of, behind or on the same level as the second layer.

5. The optical filter according to claim 2,
wherein the first layer is formed only at the first area.

6. The optical filter according to claim 2,
wherein the second layer is formed at the first area as well as the second area.

7. The optical filter according to claim 2,
wherein the first layer and the second layer are formed at a periphery of the optical filter.

8. The optical filter according to claim 2,
wherein the second light blocking ratio is 70˜99%.

9. The optical filter according to claim 2,
wherein at least one of the first layer and the second layer has a color.

10. The optical filter according to claim 1, further comprising a second layer which is formed at the first area and a second area,
wherein the amount of light transmitted through the first area at which both the first layer and the second layer are layered is smaller than the amount of light transmitted through the second area at which only the second layer is formed such that the first area becomes distinguished to form the dark mark or the second area becomes distinguished to form a bright mark.

11. The optical filter according to claim 1, further comprising second to n^{th} layers which are formed on second to n^{th} areas and have second to n^{th} light blocking ratios lower than the first light blocking ratio respectively,
wherein the amount of light transmitted through the first area is smaller than the amounts of light transmitted through the second to n^{th} areas to display a mark, where n≧2.

12. The optical filter according to claim 1,
wherein the first layer is a coating layer of a black ceramic material or a film containing a black ceramic material.

13. The optical filter according to claim 1,
wherein the optical filter further comprises at least one of a base substrate, a conductive film layer, a conductive mesh layer, and an anti-reflection layer.

14. The optical filter according to claim 1,
wherein the display device is a PDP device or an LCD device.

15. A display device comprising:
a display panel displaying an image; and
an optical filter placed in front of the display panel, the optical filter comprising a first layer which is formed at a first area and has a first light blocking ratio,
wherein the amount of light transmitted through the first area is smaller than the amount of light transmitted through an adjacent area to the first area such that the first area becomes distinguished to form a dark mark or the adjacent area becomes distinguished to form a bright mark.
